(19) United States
(12) Patent Application Publication
(10) Pub. No.: US 2022/0154880 A1
(43) Pub. Date: May 19, 2022

(54) TANK FOR PRESSURIZED GAS

(71) Applicant: FAURECIA SYSTEMES D'ECHAPPEMENT, NANTERRE (FR)

(72) Inventors: Nicolas HEITZ, CANCALE (FR); Patrice KERFORN, DOL DE BRETAGNE (FR)

(21) Appl. No.: 17/439,056

(22) PCT Filed: Mar. 20, 2020
(86) PCT No.: PCT/EP2020/057880

§ 371 Date: Sep. 14, 2021

(30) Foreign Application Priority Data
Mar. 22, 2019 (FR) RE1902983

(51) Int. Cl. F17C 1/00

(52) U.S. Cl. CPC F17C 1/005; F17C 2260/037; F17C 2201/056; F17C 2201/058; F17C 2203/0604; F17C 2203/0619; F17C 2203/066; F17C 2203/0663; F17C 2205/0305; F17C 2205/0397; F17C 2209/228; F17C 2209/234; F17C 2221/012; F17C 2223/0123; F17C 2223/036; F17C 2201/0109

(57) ABSTRACT

A tank for pressurized gas, such as hydrogen, comprises a structure defining a volume of the tank and having at least one opening. There are as many bases as there are openings, with each base being disposed in one of the openings. A sealing enclosure covers an entire internal surface of the structure and interfaces with the base. At least one conduit allows leakage between an outer surface of the sealing enclosure and an outside of the tank. The base has a recessed external profile with an undercut at an interface with the structure. The at least one conduit comprises at least one chute interposed between the structure and the base.

### CROSS-REFERENCE TO RELATED APPLICATIONS

This application is the US national phase of PCT/EP2020/057880, which was filed on Mar. 20, 2020, which claims priority to FR 19 02983, filed Mar. 22, 2019.

### FIELD OF THE DISCLOSURE

The disclosure relates to the field of tanks for pressurized gas, such as hydrogen.

### BACKGROUND

In a most commonly used embodiment, such tanks comprise a structure, defining a volume of the tank, and a sealing enclosure covering the entire internal surface of the structure to ensure gas-tightness. However, the gas molecule, particularly in the case of hydrogen, can be very small, and the gas manages to pass through the enclosure in small quantities. This accumulated gas, given the very high storage pressures, will eventually deform the enclosure.

It is also known to create a very small leak between an accumulation zone on the outer surface of the enclosure and the outside of the tank, so that the gas trapped between the structure and the enclosure can escape from the tank before it can deform the enclosure.

The structure of the tank has an opening, and the tank further comprises a base disposed in said opening. This base, generally made of metal, usually includes at least one through-channel to allow the filling and/or drawing of gas.

It is known in the prior art that a leakage conduit is provided in the thickness or at the periphery of said base. Thus, FR 3015630 discloses a conduit pierced in the base to connect the accumulation zone with a filling and/or drawing channel.

CA 3013367 discloses a flange, disposed between the base and the structure, said flange being shaped to provide a leakage path at its inner surface. However, in order to be produced and to be placed around the base, such a flange comprising a leakage conduit does not allow the base to have a recessed external profile with an undercut at its interface with the structure.

### SUMMARY

The subject disclosure provides a configuration, where the base has a recessed external profile with an undercut at its interface with the structure This configuration is very advantageous in that it ensures that the base cannot sink into the opening and enter the interior of the structure.

Such a system overcomes the defects, disadvantages, and obstacles of the prior art, in particular a system is provided that makes it possible to produce a leakage conduit with a base having a recessed external profile with an undercut at its interface with the structure.

In one exemplary embodiment, the disclosure relates to a tank for pressurized gas, such as hydrogen, comprising a structure defining a volume of the tank and having at least one opening. There are as many bases as openings, with each base being disposed in at least one opening. A sealing enclosure covers an entire internal surface of the structure and interfaces with said at least one base. At least one conduit allows leakage between an outer surface of the enclosure and an outside of the tank. At least one of the at least one base has a recessed external profile with an undercut at an interface with the structure. At least one conduit comprises at least one chute interposed between the structure and the at least one base.

Particular features or embodiments, which may be used alone or in combination, are:

a chute fluidly connects the outer surface of the enclosure to the outside of the tank, said at least one conduit further comprises a bore in said at least one base, one end of which opens out in contact with the outer surface of the enclosure, and a chute fluidly connects the other end of the bore to the outside of the tank,

a chute has an “O” shaped channel profile or a “U” shaped half channel profile, said “U” preferably facing the base,

a chute conforms to the profile of said at least one base,

said at least one base is substantially rotationally symmetrical about an axis and a chute is arranged substantially axially along said axis and/or a possible bore is arranged substantially axially along said axis,

the tank further comprises a flange covering at least the entire external surface of said at least one base facing the surface of the structure not covered by said at least one chute,

the chute is made of a plastic material that can be welded to the flange material,

the chute is glued, clipped, welded or bolted to at least one base and/or to the flange, if any.

### BRIEF DESCRIPTION OF THE DRAWINGS

The disclosure will be better understood upon reading the following description, given only as an example, and with reference to the attached drawings, in which:

FIG. 1 shows a cutaway view of the part of a tank around its opening,

FIG. 2 shows a perspective view of a chute,

FIG. 3 shows an exploded perspective view of the part of a tank around its opening, and

FIG. 4 shows a perspective view of the part of a tank around its opening.

### DESCRIPTION OF THE EMBODIMENTS

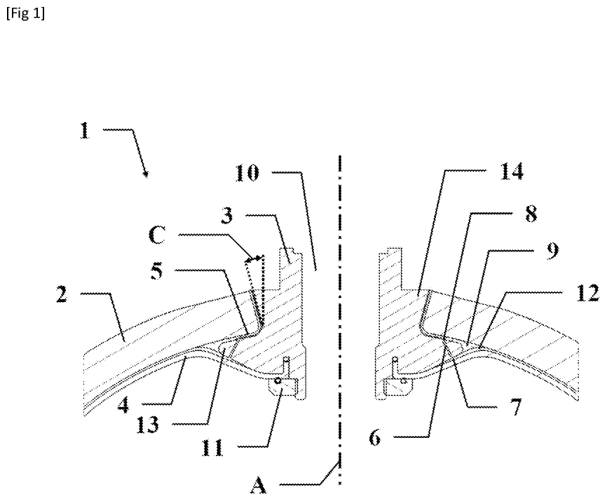

With reference to FIG. 1, which illustrates an embodiment of a tank 1 for pressurized gas, such as hydrogen, such a tank 1 has a substantially rotationally symmetrical shape about an axis A. The tank 1 comprises a structure 2, which can be produced in particular by winding a fiber, such as a glass fiber or a carbon fiber, previously coated with a binder, such as an epoxy, polyester or thermoplastic resin. Said structure 2 gives rigidity to the tank and defines its volume. The structure 2 cannot keep pressurized gas sealed inside. The tank 1 also includes a sealing enclosure 4. This enclosure 4, which is usually flexible and made of elastomer and/or thermoplastic material, covers the entire internal surface of the structure 2 to ensure gas-tightness.

In order to allow the filling and/or drawing of gas, at least one opening is provided in the structure 2 of the tank 1. The tank 1 further comprises a base 3 fittingly disposed in each of said at least one opening. The fit is achieved here by building the structure 2 around the base, typically by filament winding. An opening in the structure 2 is formed by the presence of a base 3. A base 3 is continuous with respect to the structure 2. According to one embodiment, a base 3, generally metallic, typically comprises at least one through-channel 10 in order to allow a connection between the inside and the outside of the tank 1 and thus the filling and/or drawing of gas. According to one embodiment, a base 3 is substantially rotationally symmetrical about the axis A. Thus, for example, a base 3 may be substantially cylindrical.

Sealing is achieved by providing a sealed interface between the enclosure 4 and the base 3. This watertight interface is achieved, for example, by a notch accommodating the end or neck of the enclosure 4, reinforced by tightening the enclosure 4 against the base 3, for example with a nut 11.

However, the gas molecule, particularly in the case of hydrogen, can be very small, and the gas manages to pass through the enclosure 4 in small quantities. This gas, accumulated in an accumulation zone 12, due to the very high storage pressures, will eventually deform the enclosure 4.

It is therefore necessary to provide a conduit ensuring a small leak between the said accumulation zone 12, i.e. between the external surface of the enclosure 4, that faces the structure 2, and the outside of the tank 1, so as to allow the gas thus trapped between the structure 2 and the enclosure 4 to exit the tank 1, before it can deform the enclosure 4.

Although not gas-tight, the structure 2 is not sufficiently porous per se to ensure said leakage. It is also not possible to pierce the structure 2 at the risk of creating a rupture that would become critical at high filling pressures.

It should be noted that a leakage conduit, taking into account the leakage rate to be ensured, has a cross-sectional dimension/diameter of less than 0.1 mm. Such a size limits the length of a bore to a maximum of 10 to 15 mm. Therefore, a leakage conduit with a bore long enough to pass through the entire base plate is generally not possible.

Also, according to the disclosure, a leakage conduit is provided between the outer surface of the enclosure 4 and the outside of the tank 1.

According to the disclosure, a base 3 advantageously has an external profile, where the base 3 interfaces with the structure 2, shaped into a recess with an undercut C, measured relative to the axis A. Such a feature is advantageous in that, in addition to the base 3 having a conventional low enlargement 13 retaining the base 3 inside the tank 1, even when subjected to gas pressure, the base 3 further comprises a high enlargement 14 formed by the undercut C, preventing the base 3 from re-entering the tank 1.

Because of this undercut C, the solution of the prior art, which produced a flange that could be placed around a base 3, is not possible. It is not possible to make such a flange and then mount it around the base 3, due to the presence of the undercut C which creates an increase in diameter, preventing such a mounting. Another solution, consisting of making such a flange directly around the base 3, typically by overmolding, is also not possible in that it requires the base 3 to be placed in a fitted mold, which is not possible because of the undercut C, which prevents demolding.

In order to overcome this disadvantage and to make it possible to produce a leakage conduit compatible with a base 3 having a recessed external profile with an undercut C at its interface with the structure 2, the disclosure advantageously introduces at least one additional part 5, in the form of a chute 5. This chute 5 is advantageously shaped to be inserted between the structure 2 and the base 3.

Said at least one chute 5 is hollow to form a fluid conduit. In a first embodiment (not shown), the chute 5 extends along the length of the leakage conduit. Thus it fluidly connects the outer surface of the enclosure 4, coinciding with the accumulation zone 12, with the outside of the tank 1.

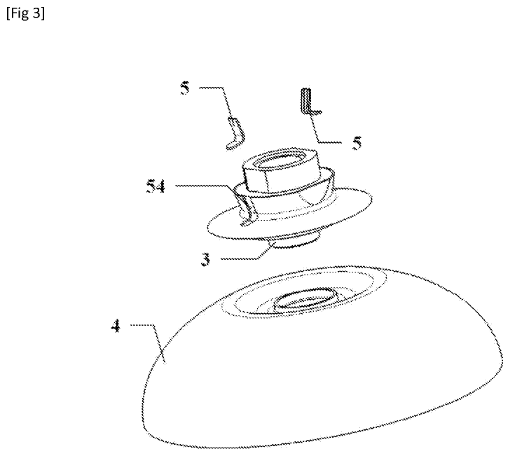

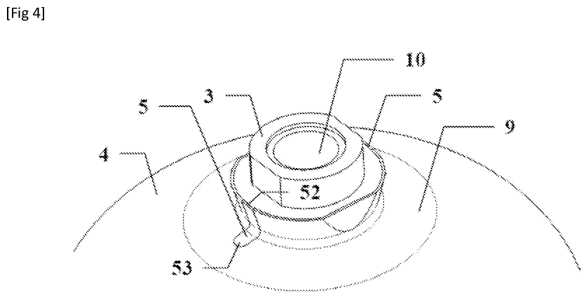

According to a second embodiment, illustrated in FIGS. 1-4, said at least one leakage conduit is made of two parts. The first part consists of a bore 6 in the base 3. Said bore 6 passes through the base 3, advantageously in its lower part, where the base 3 has a low enlargement 13, holding the base inside the tank 1. One end 7 of this bore 6 opens out in contact with the outer surface of the enclosure 4, i.e. in the accumulation zone 12. The other end 8 opens out above the said bottom enlargement 13. A chute 5 is shaped to fluidly connect the outlet of said end 8 of the bore 6 with the outside of the tank 1.

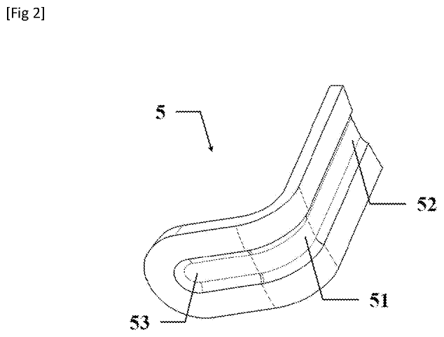

According to the embodiment illustrated in detail in FIG. 2, a chute 5 has a generally angled shape to follow the recessed profile of the base 3. In this form there is a longitudinal groove 51. Said groove 51 ends in a rounding 53 capable of covering the outlet of the end 8, and in an end 52 on the outside of the tank.

According to a further feature, in a first embodiment (not shown), a chute 5 has a recessed closed profile, i.e. an “O” shaped channel profile. Alternatively, according to a second embodiment, as illustrated more particularly in FIG. 2, a chute 5 has a recessed open profile, i.e. a “U” shaped half-channel profile. Said “U” can face towards the base 3 or the structure 2. Preferably, as illustrated in the embodiment shown in FIGS. 1-4, the “U” opening faces the base 3.

According to another feature, and mainly in the case of a half-channel profile, the shape of a chute 5 follows the profile of the base 3. This ensures that the conduit is sealed by pressing the chute 5 against the base 3. The outer surface of the base facing the chute 5 completes the recessed open profile of the groove 51 to obtain a closed profile and ensure sealing.

According to another characteristic, a base 3 is substantially rotationally symmetrical about an axis A, for example substantially symmetrical, and a chute 5 is arranged substantially axially along said axis A. Similarly, in an embodiment comprising a bore 6, the latter is advantageously arranged substantially axially along said axis A, as illustrated in the figures. Axially arranged means arranged in a plane through the axis A and preferably substantially parallel to the axis A.

According to another characteristic, the tank 1 further comprises a flange 9 covering at least the entire external surface of a base 3 facing the surface of the structure 2 not covered by said at least one chute 5. Thus the flange 9 and the at least one chute 5 are dimensionally fitted and together completely cover the surface of the base 3 facing the structure 2. Also, by making the flange 9 and the at least one chute 5 of a dielectric material, it is possible to electrically isolate the base 3 from the structure 2. This is advantageous in that it creates an electrolytic break between the base 3 and the structure 2.

In order to achieve a tight fit, the flange 9 has a cut-out 54 dimensionally adapted to the shape of a chute 5.

Another advantageous feature is that a chute 5 is made of a plastic material that can be welded to the material of the flange 9, preferably of the same material.

It is possible to envisage any way of assembling or fastening a chute 5 either to a base 3 or to a flange 9, if such a flange 9 is present. Thus, a chute 5 can be fixed by gluing, clipping, welding or heat staking. Such welding or heat staking is advantageously carried out by laser or ultrasound.

The disclosure has been illustrated and described in detail in the drawings and the preceding description. This should be considered as illustrative and by way of example and not as limiting the disclosure to this description alone. Numerous other embodiments are possible.

1. A tank for pressurized gas, such as hydrogen, comprising:
a structure defining a volume of the tank and having at least one opening one base disposed in each opening;
a sealing enclosure covering an entire internal surface of the structure and interfacing with said base; and
at least one conduit allowing leakage between an outer surface of the sealing enclosure and an outside of the tank, wherein at least one of said base has a recessed external profile with an undercut at an interface with the structure, and wherein the at least one conduit comprises at least one chute interposed between the structure and said at least one base.

2. The tank according to claim 1, wherein one of the at least one chute fluidly connects the outer surface of the sealing enclosure to the outside of the tank.

3. The tank according to claim 1, wherein the at least one conduit further comprises a bore in said at least one base, one end of which opens out in contact with the outer surface of the sealing enclosure and wherein one of the at least one chute fluidly connects an opposite end of the bore the outside of the tank.

4. The tank according to claim 1, wherein one of the at least one chute has an “O” shaped channel profile.

5. The tank according to claim 1, wherein one of the at least on chute conforms to a profile of said at least one base.

6. The tank according to a claim 1, wherein said at least one base is rotationally symmetrical about an axis and one of the at least one chute is disposed axially along the axis and/or a bore is disposed axially along the axis.

7. The tank according to claim 1, further comprising a flange covering at least an entire external surface of said at least one base opposite a surface of the structure not covered by the at least one chute.

8. The tank according to claim 7, wherein the at least one chute is made of a plastic material weldable with a material of the flange.

9. The tank according to claim 7, wherein the at least one chute is fixed by gluing, clipping, welding, or bolting to said at least one base.

10. The tank according to claim 7, wherein the at least one chute is fixed by gluing, clipping, welding, or bolting to the flange.

11. The tank according to claim 1, wherein one of the at least one chute has a U-shaped half channel profile.

12. The tank according to claim 11, wherein an open portion of the U-shaped half channel profile faces the base.
